(19) United States
(12) Patent Application Publication
(10) Pub. No.: US 2007/0247675 A1
(43) Pub. Date: Oct. 25, 2007

(54) IMAGE FORMING APPARATUS AND SHEET MEDIUM PROCESSING APPARATUS

(75) Inventor: Hisaya Ishio, Toda-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/737,335

(22) Filed: Apr. 19, 2007

(30) Foreign Application Priority Data
Apr. 20, 2006 (JP) 2006-117118

(51) Int. Cl. H04N 1/04

(52) U.S. Cl. 358/486

(57) ABSTRACT

A sheet medium processing apparatus includes a guiding passage connected to a passage branch section which can branch a part of a medium passage directed to a discharge tray section positioned on an image forming apparatus side when a sheet medium is output from the image forming apparatus, and a discharge tray for holding the sheet medium fed through the guiding passage. The discharge tray is positioned lower than the discharge tray section, and at least parts of the passage branch section and the guiding passage section are covered with the discharge tray section.

### CROSS-REFERENCE TO RELATED APPLICATIONS

This application is based upon and claims the benefit of priority from prior Japanese Patent Application No. 2006-117118, filed Apr. 20, 2006, the entire contents of which are incorporated herein by reference.

### BACKGROUND OF THE INVENTION

1. Field of the Invention

The present invention relates to an image forming apparatus which can easily take out a sheet medium containing an image or a document output thereto, and a sheet medium processing apparatus.

2. Description of the Related Art

An image forming apparatus such a color copying machine or a printer includes a discharge tray for temporarily holding a sheet medium to which an image or a document has been output until a user brings it home.

Today, a finisher apparatus (sheet processing apparatus) is widely used for, for example, collating or stapling sheet media to which images or documents have been output.

For example, Jpn. Pat. Appln. KOKAI Publication No. 2004-109646 discloses a finisher apparatus in which a main discharge tray is positioned directly below a sub-discharge tray. Accordingly, a space for taking out sheets discharged from the main discharge tray is smaller.

The sub-discharge tray and the main discharge tray are both positioned on an image forming apparatus main body side. Thus, a user who works near the image forming apparatus or the sheet medium processing apparatus is required to move to bring (take out) the sheets home (the user who works near the image forming apparatus must adopt an unnatural posture to take out the sheets in this place).

### BRIEF SUMMARY OF THE INVENTION

It is an object of the present invention to provide an image forming apparatus which can easily take out a sheet medium containing an image or a document output thereto even in a loaded status of a sheet medium processing apparatus, and the sheet medium processing apparatus.

The present invention provides an image forming apparatus comprising:

an image reading section which generates image data;

an image forming section which outputs an image corresponding to the image data to an output medium;

a first medium holding section arranged in a position nearly equal to a position of the image reading section in a height direction or at a height within a predetermined range with respect to the position of the image reading section to hold the output medium to which the image has been output from the image forming section; and

a second medium holding section which holds the output medium containing the image output thereto from the image forming section in a position lower than the first medium holding section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEW OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a schematic diagram showing an example of an image forming apparatus according to a first embodiment of the present invention;

FIG. 2 is a schematic diagram showing an example of a convey path of a sheet medium in the image forming apparatus shown in FIG. 1;

FIG. 3 is a schematic diagram showing flows of an image signal of the image forming apparatus and signals for controlling components shown in FIGS. 1 and 2;

FIG. 4 is a schematic diagram showing an example of a convey path of a sheet medium in another image forming apparatus different from that shown in FIGS. 1 to 3; and

FIG. 5 is a schematic diagram showing flows of an image signal of the image forming apparatus and signals for controlling components shown in FIG. 4.

### DETAILED DESCRIPTION OF THE INVENTION

The preferred embodiments of the present invention will be described below with reference to the accompanying drawings.

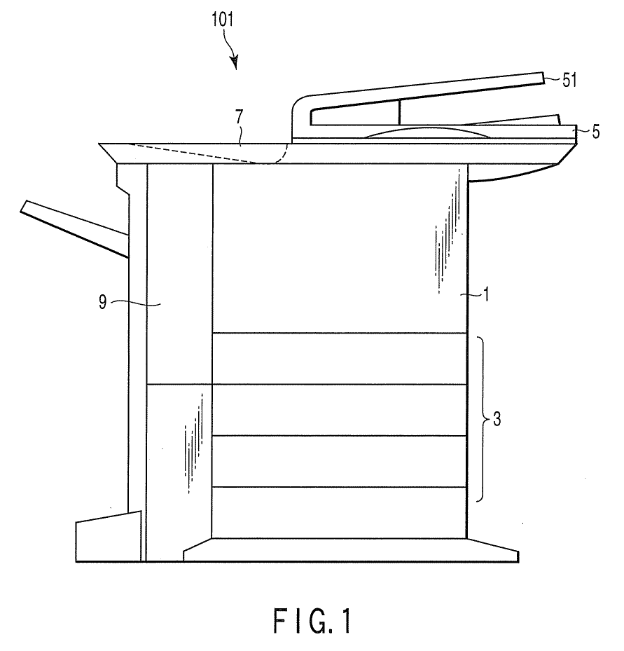

FIG. 1 shows an example of an image forming apparatus according to an embodiment of the present invention.

An image forming apparatus 101 shown in FIG. 1 includes an image forming section (engine) 1 for outputting image information of characters, photos or graphics as an image output called, for example, a hard copy or a printout, a sheet feeding section 3 for feeding sheet media (sheets hereinafter) of optional sizes used for outputting images to the image forming section 1, and an image reading section (scanner) 5 for fetching the image information which is an image forming target in the image forming section 1 as image data from a target (document hereinafter) holding the image information. The image reading section 5 (not described in detail) includes a document table for supporting the target and an image sensor such as a CCD sensor for converting the image information into image data. In the image reading section 5, a light is applied from a lighting device (not shown) to a document set on the document table to transmit a reflected light containing image information of the document as bright and dark parts of the light from the document to the CCD sensor.

The image reading section 5 includes an automatic document feeder (ADF) 5A integrally disposed to send a read document to a predetermined position after forming of an image output or fetching of image information (reading hereinafter) is finished, and to guide a next document to a reading position when documents are sheets. Needless to say, in place of the ADF 5A, a document cover (document pressing member) not shown may be used. The CCD sensor of the image reading section 5 is disposed in an optional position of a convey path for conveying the documents independently of the document table. Accordingly, image information of a document being conveyed can be read as image data without positioning the document on the document table.

In a predetermined position above the image forming section 1 and on the side of image reading section 5, a discharge tray 7 is disposed to hold a sheet to which an image formed by the image forming section 1 has been transferred and fixed. The discharge tray 7 is practically formed in such a position that a user working near the image reading section 5 can take out (bring home) a sheet held by the discharge tray 7 without moving from the place to feed a document as a sheetlike reading target to the image reading section 5 via the ADF 5A near the image forming section 5. For example, as a position relatively close to user's work position for copying work, a distance between the document reading section 5 and the discharge tray 7 is preferably set to a distance equivalent to one sheet (length of a short direction), or a slightly smaller distance. When a finisher device 9 is connected, a size of an exterior member (cover) for covering the discharge tray 7 and its surroundings is defined to a size to enable covering of a major part of the finisher device 9 when seen from a planar direction.

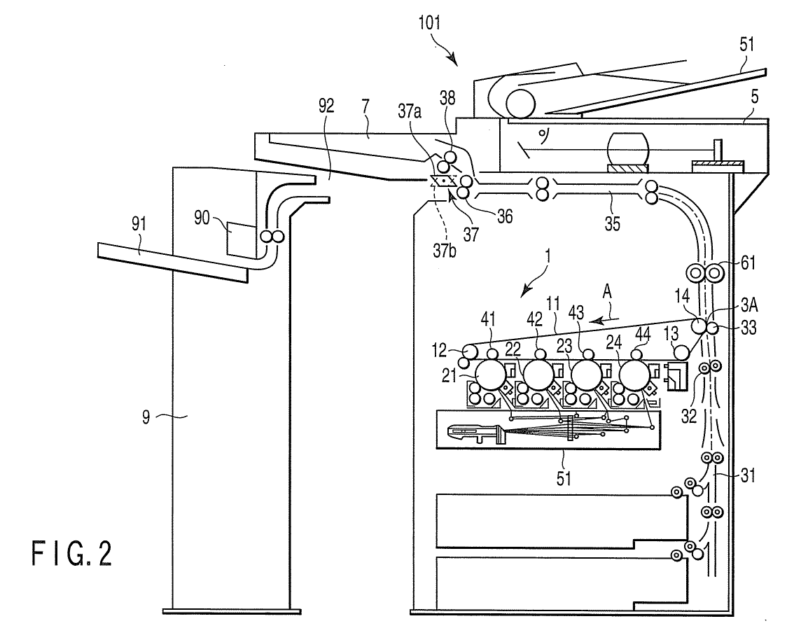

The finisher device 9 to which the image formed by the image forming section 1 is transferred and which can hold the optional number of fixed sheets under predesignated conditions can be connected to a backstream side of the image forming section 1 and the image reading section 5. FIG. 1 shows a status in which the finisher device 9 is connected to the image forming apparatus 101, and FIG. 2 shows a status in which the finisher device 9 is disconnected from the image forming apparatus 101.

For example, the finisher device 9 collates or staples the optional number of sheets P having images fixed thereon. The finisher device 9 is disposed independently of the image forming apparatus 101. When the finisher device 9 is connected, an image is formed by the image forming apparatus 101, and a sheet to be discharged is discharged to one of the discharge tray 7 on the image forming section 1 and the finisher device 9.

As schematically shown in FIG. 2, for example, the image forming section 1 includes an intermediate transferring belt 11 in which an insulating film of a predetermined thickness is formed into a belt shape. For the intermediate transferring belt 11, a belt prepared by forming a metal into a thin sheet shape and protecting a surface with a resin can be used.

Predetermined tension is applied to the intermediate transfer roller 11 by a drive roller 12 and first and second tension rollers 13 and 14, and an optional position parallel to an axis of the drive roller 12 is moved in an arrow direction A by rotating the drive roller 12. In other words, a belt surface of the intermediate transfer belt 11 is circulated in a direction indicated by the arrow A at a speed of moving an outer peripheral surface of the drive roller 12.

In a section in which the belt surface of the intermediate transfer belt 11 is moved practically in a planar shape, first to fourth image forming units 21 to 24 are arrayed at predetermined spaces. In an example of FIG. 2, in a section in which the intermediate transfer belt 11 is moved practically in a planar shape between the drive roller 12 and the first tension roller 13, the first image forming unit 21 is positioned on the drive roller 12 side, and the fourth image forming unit 24 is positioned on the first tension roller 13 side.

Each of the first to fourth image forming units 21 to 24 includes at least a developing device for receiving toner of an optional color of yellow (Y), magenta (M), cyan (C), and black (Bk), and a photosensitive drum for holding an electrostatic image to be developed by the developing device.

In a photosensitive body of each image forming unit, an electrostatic image of a color to be developed by the developing device of the image forming unit is formed by an image light from an exposure device 51, and developed by toner selectively fed from a corresponding developing device. In each of the image forming units 21 to 24, for example, the photosensitive drum (not described in detail) is charged to a predetermined potential by a noncontact (corona discharge) or contact (charge roller) method.

On a backside of the intermediate transfer belt 11 set among the first to fourth image forming units 21 to 24, transfer rollers 41 to 44 are disposed on the photosensitive drum of the image forming units to transfer a toner image which is a developer image obtained by developing an electrostatic image by the developing device.

In the image forming units 21 to 24, electrostatic images are formed by predetermined timing to be developed by corresponding developing devices on the intermediate transfer belt 11 so that toner images to be sequentially transferred can be stacked together on the intermediate transfer belt 11.

The toner images stacked together on the intermediate transfer belt 11 are fed from an optional cassette of a sheet feeding section 3, and transferred to a sheet P guided to a transfer position 3A through a convey path 31 by a transfer roller 33 brought into contact with the intermediate transfer belt 11 by predetermined pressure. The sheet P guided to the transfer position 3A is controlled for its positional relation with the toner images conveyed on the intermediate transfer belt 11 by a registration roller 32.

The sheet P having the toner images transferred thereto by the transfer roller 33 is further conveyed through the convey path 31, and the toner images are fixed by a fixing device 61.

The sheet P having the toner images fixed thereon is discharged through a discharge convey path 35 and a discharge branch section 37 to the discharge tray 7 disposed on the image reading section 5 side above the image forming section 1. When the finisher device 9 is connected, by user's selection instruction, for example, selection by an operation panel or designation of print cue transmission, the sheet P is guided to the discharge tray 7 or the finisher device 9 via the discharge branch section 37.

The finisher device 9 includes a stapler 90 for stapling the sheet P guided through the discharge convey path 35 of the image forming section 1, and a discharge tray 91. The discharge tray 91 of the finisher device 9 is defined in a position lower than discharge tray 7. The distance between the discharge tray 91 and the image reading section 5 (image forming section 1) is larger than the distance between the discharge tray 7 of the image forming section 1. In other words, the discharge trays 7 and 91 are disposed to be offset in horizontal and height directions.

For connection with the image forming section 1, the finisher device 9 includes a connection section 92 connected to the discharge branch section 37 of the image forming section 1 by loading the finisher device 9 toward the image forming section 1 (image forming apparatus 101).

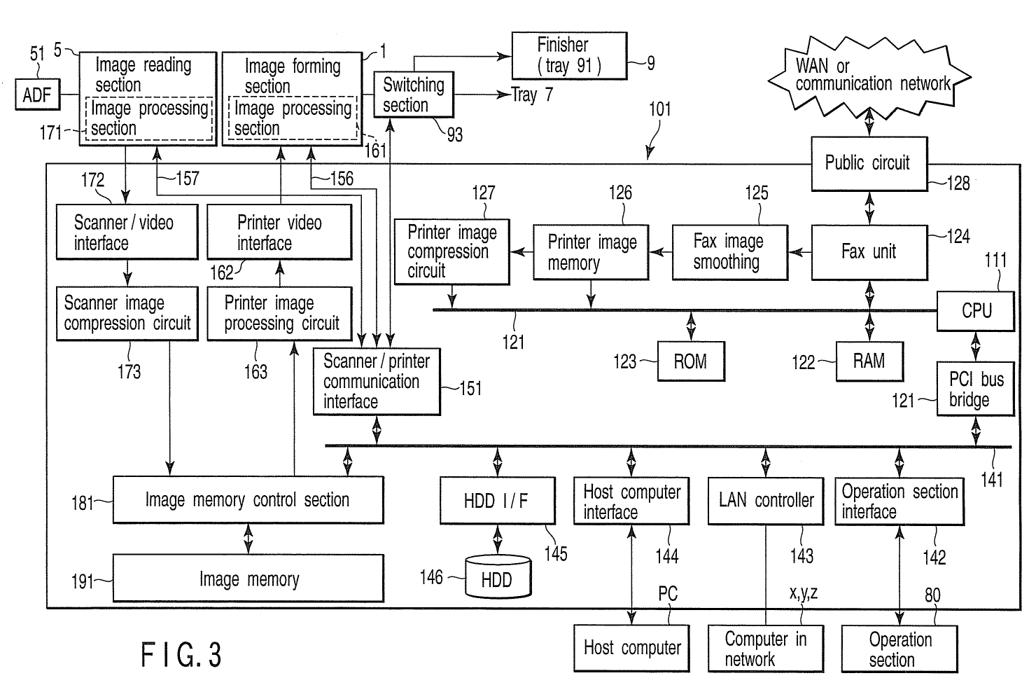

When used for actually discharging the sheet P, the discharge branch section 37 of the image forming section 1 is switched between the discharge tray 7 side 37a indicated by a solid line and the discharge tray 91 side 37b of the finisher device 9 indicated by the dotted line by a switching device 93 shown in FIG. 3 at optional timing to discharge the sheet to one of the discharge tray 7 (image forming section 1) and the discharge tray 91 (finisher device 9).

For example, when the sheet P is discharged to the discharge tray 7 of the image forming apparatus 101, the branch section 37 is switched to the side 37a indicated by the solid line to branch the sheet P conveyed by the discharge roller 36 to a transmission roller 38 side therefrom, and the sheet P is discharged to the tray 7 by the transmission roller 38.

For example, when the sheet P is discharged to the discharge tray 91 of the finisher device 91, the branch section 37 is switched to the side 37b indicated by the dotted line to branch the sheet P conveyed by the discharge roller 36 to the connection section 92 side therefrom, and the sheet P is discharged to the discharge tray 91.

FIG. 3 schematically shows a control block used for controlling the image forming apparatus 101 shown in FIGS. 1 and 2.

As shown in FIG. 3, the image forming apparatus 101 includes a main control block (CPU) 111, a CPU local bus 121 connected to the CPU 111, a peripheral component interconnect (PCI) bus bridge 131 connected to the CPU 111, and a PCI bus 141 connected to the PCI bus bridge 131.

For example, a RAM 122 and a ROM 123 are connected to the CPU local bus 121. The RAM 122 is used as a program memory or a data storage area for enabling the CPU 111 to execute processing. The ROM 123 is used as a storage area of a boot program necessary for starting a system, a program for enabling the CPU 111 to realize various functions, and fixed data. The program and the data of the ROM 123 may be held as compressed data in the ROM 123, and developed and executed in the RAM 122.

The image forming section (printer section) 1 and the image reading section (scanner section) 5 are connected to the PCI bus 141 via a scanner/printer communication interface 151.

An operation section 80 is connected to the PCI bus 141 via an operation interface 142. The operation section (instruction input/display section) 80 (not described in detail) includes a touch panel sensor used for user's operation (ON/OFF) instruction, mode selection (selection instruction), numerical value inputting or function selection (selection inputting), a graphical display for displaying corresponding to an instruction by the touch panel or displaying a response screen corresponding to selection inputting, a dedicated button highly frequently used for inputting a numeral such as the number of copied (printed) sheets (numeral) or starting/canceling, and a status display LED. In the operation unit 80, the user can set which of the discharge tray 7 of the image forming section 1 and the discharge tray 91 (of the finisher device 9 when it is connected) the sheet P having an image output thereto is discharged.

The PCI bus 141 is connected to an optional computer or other multi-functional peripherals (MFP) x to z present in a network via a local area network (LAN) controller 143.

An external device such as a host computer PC is connected to the PCI bus 141 via a host computer interface 144. For example, the host computer interface 144 is a well-known interface such as Ethernet®, a universal serial bus (USB), IEEE 1284, or IEEE 1394.

A hard disk drive (HDD) 148 for holding large-capacity data is connected to the PCI bus 141 via an HDD interface 145. The image forming apparatus 101 can execute fax communication which uses WAN or a connection network connected through a public line 128 via a fax unit 124 connected to the CPU local bus 121.

The main control block 111 transfers a control signal with each of the image forming section 1 and the image reading section 5 connected via the scanner/printer communication interface 151. Thereby, the main control block 111 controls an operation of the image reading section 5 to read color or black and white image data, and controls the image forming section 1 to output color or black and white image data.

The read image data is temporarily stored in an image memory 191. Thus, one reading operation of a document image enables repeated outputting of the necessary number of images (outputting of a plurality of images), “N-up” outputting for reducing plural pages of images on one sheet to arrange them, image rotation for enabling optional collation of a 90-degree unit of the document image, form synthesis for constituting a form frame, or synthesis of dates, logo marks or watermarks.

The read image data is compressed by encoding in an image processing section 171 or an image memory control section 181 as occasion demands. Accordingly, the amount of image data held in the HDD 148 can be reduced. The compression enables storage of more image data in the HDD 148. By outputting the image data temporarily stored in the HDD 148 in optional sequence and by an optional number of times, outputting (printing out) of the requested optional number (sheets) called electronic sort is enabled.

The scanner/printer communication interface 151 transfers a command or control information on a status with the image forming section (printer) 1 and the image reading section (scanner) 5 through serial communication 157 with the scanner (image reading section) 5 and serial communication 156 with the printer (image forming section) 1. Accordingly, information on a starter or operated status of the image forming apparatus 101, acquisition of a size or a type of a read document, designation of a sheet size, or the residual amount of toner or sheets can be reported to the CPU 111. The scanner/printer communication interface 151 outputs a switching signal to the switching device 93 to discharge the sheet P to the discharge tray 7 or 91 designated from the operation section 80 by the user. For the switching device 93, various well-known structures such as a solenoid in which the discharge tray 7 is used during a non operation, and an electromagnet for switching an upper guide to 92a or 37a during an operation can be used. Needless to say, for example, a mechanical switching mechanism may be disposed in the finisher device 9 (or image forming section 1) to be directly operated by the user.

The image forming apparatus 101 can receive image data for image outputting from peripheral (external) devices connected through various connections such as local connection such as IEEE 1284, IEEE 1394 or USB (connection by the host computer interface 144), LAN connection via the LAN controller 143, and connection to a communication network or a wide area network (WAN) via the public line 128 connected to the fax unit (modem) 124 to output (print out) the data.

In the image forming apparatus 101, image data read by the image reading section 5 is input to a scanner compression circuit 173 via a scanner video interface 172, and compressed by the image compression circuit 173 to be stored in the image memory 191 via the image memory control section 181.

A printer image processing circuit 163 converts an image into a common image form required in the image forming section 1 to output image data to the image forming section 1 via a printer video interface 162. In the image processing section 161 of the image forming section 1, the image data of the image memory 191 is encoded or decoded. For this encoding/decoding, reversible variable length encoding (rule) is used.

The image memory control section 181 controls the large-capacity image memory 191 for storing encoded data of an uncompressed or compressed image. The image memory control section 181 controls reading of image data from the image reading section 5 into the image memory 191 or printing out (outputting) of image data from the image memory 191 to the image forming section 1.

The image memory control section 181 can handle image data of various formats. For a monochrome image or a color image in a binary image, and monochrome and color image data of a copy function and a network printer function in a multivalued image, an optimal compression method can be selected in accordance with functions to be used.

For example, when the user requests printing-out to the image forming apparatus 101 by the host computer PC, a control signal is input from the host computer PC to the main control block (CPU) 111 via the host computer interface 144.

Image data to be printed out is stored in the image memory 191 via the PCI bus 141 and the image memory control section 181.

Under control of the CPU 111, the image data stored in the image memory 191 is fed to the printer image processing circuit 163 at predetermined timing (via the image memory control section 181).

The image data fed to the printer image processing circuit 163 is input to the image processing section 161 of the image forming section (printer) 1 via the printer video interface 162, and converted into raster data to be output from the exposure device 51.

An image light (exposure light) corresponding to the image data is output from the exposure device 51 to the photosensitive drums of the image forming units 21 to 24 holding developers (toner) of corresponding colors.

In each of the image forming units 21 to 24, an electrostatic image (electrostatic latent image) corresponding to the exposure light from the exposure device 51 is formed on the photosensitive drum.

The electrostatic latent image formed on each photosensitive drum is developed by toner of a requested color to be visible.

Toner images of four colors formed by the image forming units 21 to 24 are sequentially transferred by the transfer rollers 41 to 44 to be stacked on the intermediate transfer belt 11.

The toner images, i.e., color images, stacked on the intermediate transfer belt 11 are transferred to sheetlike media, i.e., sheets P, aligned in timing with image positions on the belt 11 to be conveyed through the convey path 31 by the transfer roller 33.

The color images transferred to the sheets P are fixed thereon by the fixing device 61.

The sheets P having the toner images fixed thereon are conveyed through the discharge convey path 35 to the discharge branch section 37, and discharged to one of the discharge trays 7 and 91 predesignated by the user. If no particular discharge tray is instructed (selected) from the user, the sheets P are discharged to the discharge tray 91 of the finisher device 9 to be output from the printer. Thus, when the user requests printing-out, a control command for switching the switching device 9 to the finisher device 9 is output beforehand from the main control block (CPU) 111 to the scanner/printer communication interface 151.

Accordingly, an image output (printout) printed out based on the print request from the host computer PC is discharged not to the discharge tray 7 of the image forming section 1 (image forming apparatus 101) main body but to the discharge tray 91 of the finisher device 9. This arrangement is advantageous in that the discharged sheets P can be easily identified to be printouts (noncopies).

In the image forming apparatus 101, for example, when the user instructs reading of image information from a sheet medium i.e., a document, using the image reading section 5 (ADF 5A) and image forming, i.e., copying, the image information of the document is fetched as light brightness and darkness by the image reading section (scanner) 5. For example, the fetched light (light brightness and darkness) is converted into an image signal by the CCD sensor, and subjected to predetermined correction by the image processing section 171.

The image subjected to the predetermined correction by the image processing section 171 is input to the scanner image compression circuit 173 via the scanner video interface 172.

An image signal that is image information of the document compressed by the scanner image compression circuit 173 is stored in the image memory 191 via the image memory control section 181.

Under control of the CPU 111, the image data stored in the image memory 191 is supplied to the printer image processing circuit 163 at predetermined timing (via the image memory control section 181).

The image data supplied to the printer image processing circuit 163 is input to the image processing section 161 of the image forming section (printer) via the printer video interface 162 to be converted into raster data to be output from the exposure device 51.

Subsequently, in a process similar to that of the printing-out, toner images corresponding to the image information of the document are formed to be transferred to the sheets P conveyed through the convey path 31 at predetermined timing.

The sheets P having the transferred color images fixed thereon by the fixing device 61 are conveyed through the discharge convey path 35 to be discharged from the discharge branch section 37 to the discharge tray 7 except when the user selects (instructs) selection of sheet discharging to the discharge tray 91 of the finisher device 9.

Accordingly, hard copies obtained by copying (duplicating) the images of the document read by the image reading section (scanner) 5 are normally stacked sequentially in the discharge tray 7 of the image forming section 1.

Thus, as compared with the case in which the printout (image output) is discharged to the discharge tray 91 of the finisher device 9, the hard copy (copy of the copying target image information of the document) is discharged to the vicinity of the document reading section 5 (ADF 5A) relatively near user's working position. This allows (enables) the user to easily take out (brings) the copy without moving from the vicinity of the main body of the image forming apparatus when enable the user takes out (brings) the hard copy.

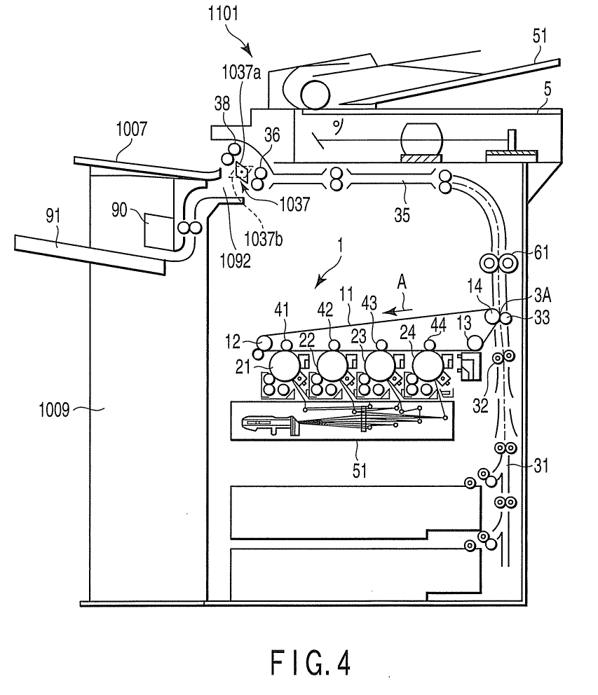

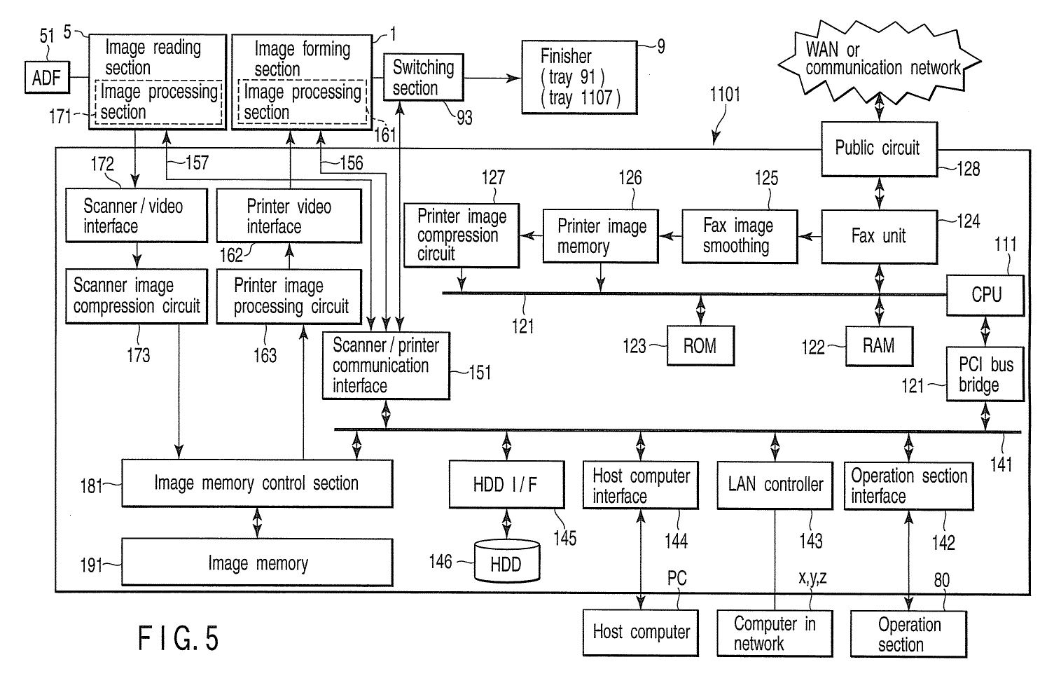

FIGS. 4 and 5 show an example of another embodiment of the image forming apparatus shown in FIGS. 1 to 3. Components similar to those described above with reference to FIGS. 1 to 3 are denoted by similar reference numerals, and detailed description thereof will be omitted.

FIGS. 4 and 5 show an example of an image forming apparatus 1101 which includes a finisher device 1009 integrally disposed normally. Needless to say, when the image forming apparatus 1101 is used singly, a branch section 1037 is fixed in a position indicated by a dotted line 1037b to enable outputting of sheets P to a discharge tray disposed near the branch section 1037 (not shown).

The finisher device 1009 includes a discharge tray 1091 to which the sheets P are fed via a connection section 1092 connected to the branch section 1037, and an upper discharge tray 1007 for holding the sheets P on an image reading section 5 side near the image reading section 5 when the branch section 1037 is switched to a position indicated by a solid line 1037a.

In other words, as shown in FIG. 5, a switching device 93 switches the branch section 1037 to enable holding of the sheets P in one of the discharge tray 1091 of the finisher device 1009 and the upper discharge tray 1007.

In FIG. 4, the branch section 1037 is positioned on the image forming apparatus 1011 side. Needless to say, however, the branch section 1037 may be disposed in the finisher device 1009.

As described above, according to the embodiment of the present invention, it is possible to obtain an image forming apparatus which can easily take out an output sheet medium, and a sheet medium discharged to the finisher device even when an external device such as a finisher device is connected. The discharge tray of the image forming apparatus and the discharge tray of the finisher device are not stacked on each other when seen from a planar direction. Thus, it is possible to prevent forgotten the takeout of sheets when the sheet media (sheets) are taken out.

A copy that is most often a job from the user working near the image forming apparatus is discharged by the discharge tray of the main body side taken out by the user without changing the working position. Hence, work efficiency is increased.

The embodiment is not limited limitative of the present invention. Various changes can be made within a scope of appended claims of the invention. Needless to say, such changes are within the invention.

What is claimed is:

1. An image forming apparatus comprising:
an image reading section which generates image data;
an image forming section which outputs an image corresponding to the image data to an output medium;
a first medium holding section arranged in a position nearly equal to a position of the image reading section in a height direction or at a height within a predetermined range with respect to the position of the image reading section to hold the output medium to which the image has been output from the image forming section; and
a second medium holding section which holds the output medium containing the image output thereto from the image forming section in a position lower than the first medium holding section.

2. The image forming apparatus according to claim 1,
wherein the first medium holding section is disposed in the same casing as that of the image reading section and the image forming section.

3. The image forming apparatus according to claim 1,
wherein the first medium holding section is disposed in a casing separable from the image reading section and the image forming section.

4. An image forming apparatus comprising:
an image reading section which generates image data;
an image forming section which outputs an image corresponding to the image data to an output medium;
a first medium holding section which holds the output medium to which the image has been output from the image forming section; and
a second medium holding section which is formed to be connected to the image forming section and which holds the output medium containing the image output thereto from the image forming section in a position more distant from the image reading section and the image forming section than a position of defining the first medium holding section between the image reading section and the image forming section.

5. The image forming apparatus according to claim 4,
wherein the first medium holding section is arranged in a position near the image reading section to cover a part of the image forming section when seen from a planar direction.

6. The image forming apparatus according to claim 4,
wherein the second medium holding section is arranged in a position to project from an area of the image reading section and the image forming section when seen from a planar direction.

7. The image forming apparatus according to claim 4,
wherein the second medium holding section is separable from the image forming section, the image reading section, and the first medium holding section.

8. The image forming apparatus according to claim 7,
wherein a main part of the second medium holding section is covered with the first medium holding section when seen from the planar direction.

9. The image forming apparatus according to claim 4,
wherein a distance between the first medium holding section and the image reading section when seen from a planar direction is equal to or less than a short-direction length of the output medium of a specific size of the output medium.

10. The image forming apparatus according to claim 6,
wherein the second medium holding section is arranged in a position lower than a position of the first medium holding section when seen from the planar direction.

11. The image forming apparatus according to claim 4, further comprising:
a switching section which switches feeding of the output medium between the second medium holding section and the first medium holding section.

12. The image forming apparatus according to claim 4, further comprising:
a switching section which switches feeding of the output medium between the second medium holding section and the first medium holding section; and
an instruction input section which inputs a switching instruction to the switching section.

13. An image forming apparatus comprising:
an image forming unit which forms a developer image corresponding to image data;
a fixing unit which fixes the developer image on a sheet medium;
a first tray formed integrally with a housing which receives the image forming unit to hold the sheet medium containing the developer image fixed thereon by the fixing unit; and
a connection section formed independently of the housing to connect a medium processing apparatus including a second tray for supporting the sheet medium to the housing when the sheet medium containing the developer image fixed thereon by the fixing unit is guided.

14. The image forming apparatus according to claim 13, further comprising:
an instruction input section which inputs an instruction to select feeding of the sheet medium to one of the first tray and the second tray when the medium processing apparatus is connected to the image forming apparatus.

15. The image forming apparatus according to claim 13,
wherein when the medium processing apparatus is connected, a main part of the medium processing apparatus for feeding the sheet medium to the second tray is covered when seen from a planar direction.

16. A sheet medium processing apparatus comprising:
a passage branch section which branches a part of a medium passage directed to a medium holding section positioned on an image forming apparatus side when a sheet medium containing a developer image fixed thereon is output from the image forming apparatus;
a guiding passage which receives the sheet medium from the passage branch section; and
a medium support section which supports the sheet medium fed through the guiding passage,
wherein the medium support section is positioned lower than the medium holding section of the image forming apparatus, and at least parts of the passage branch section and the guiding passage are covered with the medium holding section when the medium holding section is seen from a planar direction.

17. An image forming apparatus comprising:
an image reading section which generates image data;
an image forming section which outputs an image corresponding to the image data to an output medium;
a first medium holding section arranged in a position nearly equal to a position of the image reading section in a height direction or at a height within a predetermined range with respect to the position of the image reading section to hold the output medium to which the image has been output from the image forming section; and
a finisher device which includes a second medium holding section disposed independently of the image reading section and the image forming section, and holds the output medium containing the image output thereto from the image forming section in a position more distant from the image reading section and the image forming section and lower than a position of the first medium holding section defined between the image reading section and the image forming section.

18. The image forming apparatus according to claim 17,
wherein the first medium holding section is disposed in the same casing as that of the image reading section and the image forming section.

19. A sheet medium processing apparatus comprising:
a passage branch section which branches a part of a medium passage directed to a medium holding section positioned on an image forming apparatus side when a sheet medium containing a developer image has been fixed thereon is output from the image forming apparatus;
a guiding passage which receives the sheet medium from the passage branch section;
a medium support section which supports the sheet medium fed through the guiding passage; and
a medium holding section which holds the sheet medium branched by the passage branch section in a position above the medium support section and offset in a direction horizontal to the medium support section.
